(19) United States
(12) Patent Application Publication
(10) Pub. No.: US 2026/0364496 A1
(43) Pub. Date: Nov. 19, 2026

(54) LUBRICANT SEALED PUMP, REMOVABLE FILTER ASSEMBLY AND COMPARTMENT FOR RETAINING FILTER

(71) Applicant: Leybold France SAS, Bourg-Lès-Valence (FR)

(72) Inventors: Kevin Boubekeur, Bourg-Lès-Valence (FR); Christian Moulin, Bourg-Lès-Valence (FR); Augustin Goure, Bourg-Lès-Valence (FR); Bouhadid Hakim, Bourg-Lès-Valence (FR); Mickael Serayet, Bourg-Lès-Valence (FR)

(21) Appl. No.: 19/133,525

(22) PCT Filed: Nov. 29, 2023
(86) PCT No.: PCT/EP2023/083594

§ 371 Date: May 28, 2025

(30) Foreign Application Priority Data
Nov. 30, 2022 (EP) 22306766.1

(51) Int. Cl. B01D 35/04; B01D 35/30; F04B 53/20

(52) U.S. Cl. CPC B01D 35/04; B01D 35/306; F04B 53/20; B01D 2201/4092

(57) ABSTRACT

A removable filter assembly for a lubricant sealed pump for filtering lubricant from fluid exhausted by the pump. The filter assembly comprises: a filter having an inlet providing fluid communication with an internal filter channel, an outer perimeter of said internal filter channel being surrounded by filter material; and a tubular mounting assembly. The tubular mounting assembly defines a channel extending from an upper end of said tubular mounting assembly when said filter assembly is mounted in said lubricant sealed pump to a lower end, said internal filter channel opening into said channel between said upper and said lower end.

### CROSS-REFERENCE OF RELATED APPLICATION

This application is a Section 371 National Stage Application of International Application No. PCT/EP2023/083594, filed Nov. 29, 2023, which is incorporated by reference in its entirety and published as WO 2024/115592 A1 on Jun. 6, 2024, the content of which is hereby incorporated by reference in its entirety and which claims priority of European Application No. 22306766.1, filed Nov. 30, 2022.

### FIELD

The field of the invention relates to lubricant or oil sealed pumps and in particular embodiments to the internal components of lubricant reservoirs for such lubricant sealed pumps.

### BACKGROUND

Pumps and in particular rotary vane pumps may operate with a lubricant such as oil providing both lubrication and sealing between the rotor and the stator of the pump.

A lubricant reservoir is associated with the pump as the source of lubricant and lubricant flows from the reservoir to the pump and fluid from the pump is exhausted through the reservoir via a mist filter within the reservoir that acts to remove small droplets of lubricant from the gas to be exhausted. Such lubricant reservoirs are conventionally formed in a single piece from aluminium and there is generally a compartment to retain the mist filter.

The filters of such pumps need to be replaced periodically and inserting and removing them can be a fiddly and dirty task. Filters are mounted in an enclosed space and require effective sealing at their inlets to the compartment into which they are mounted. Furthermore, the lubricant in the reservoir of such a pump needs periodically replacing and to fill the reservoir may require an inlet which may increase the size and complexity of the lubricant reservoir and/or be difficult to access.

It would be desirable to provide a means for simplifying at least one of inserting and removing a filter and replacing the lubricant in a lubricant sealed pump.

The discussion above is merely provided for general background information and is not intended to be used as an aid in determining the scope of the claimed subject matter. The claimed subject matter is not limited to implementations that solve any or all disadvantages noted in the background.

### SUMMARY

A first aspect provides a filter assembly for a lubricant sealed pump for filtering lubricant from fluid exhausted by said pump, said filter assembly comprising:
a filter comprising an inlet providing fluid communication with an internal filter channel, an outer perimeter of said internal filter channel being surrounded by filter material; and a tubular mounting assembly; said tubular mounting assembly defining a channel extending from an upper end of said tubular mounting assembly when said filter assembly is mounted in said lubricant sealed pump, to a lower end, said filter inlet opening into said channel between said upper and said lower end.

Exhaust filters within a lubricant sealed pump need to be replaced and insertion and removal can be difficult. Furthermore, the filling of the oil reservoir generally requires a dedicated inlet that may increase the size of the casing. By providing a filter assembly with a tubular mounting assembly the filter can be simply mounted within an inner compartment of a lubricant sealed pump by insertion of the lower end of the tubular assembly into a corresponding receiving aperture in the inner compartment. This acts both as an inlet to the filter assembly and also as a support means for mounting the filter assembly. Furthermore, the channel within the tubular mounting means does not only function as a channel for exhaust gas flowing from the pump during operation but may also function as inlet channel for providing lubricant to the lubricant reservoir of the pump. In this way an inlet for providing lubricant to the pump is provided within the filter assembly which removes the need for an additional dedicated inlet at some other place on the casing.

In some embodiments, said upper end of said tubular mounting assembly comprises a means for engaging with a plug.

During operation of the pump the upper end of the tubular mounting assembly should be sealed such that exhaust gas entering the lower end exits via the filter. However, when the pump is to be filled with lubricant access to the upper end of the tube is required and thus, plugging it with a removable plug provides access and sealing as required.

The plug may be attached to the filter assembly in a number of ways but in some embodiments, said means comprises a screw thread for engaging with a corresponding screw thread on said plug. The screw thread may have a shape configured to be fluid tight.

In some embodiments, an outer perimeter of said lower end of said tubular mounting assembly comprises a receiving means for receiving a seal.

In some embodiments said receiving means comprises a groove.

The lower end of the tubular mounting assembly may act as a supporting means for supporting the filter assembly within the inner compartment of a pump, but it also provides a channel for the flow of exhaust gas to the filter and as such providing a seal between the outer perimeter of the tubular assembly and the inner compartment allows exhaust gas entering the inner compartment to be channelled through the filter.

In some embodiments, said channel within said tubular mounting means is substantially perpendicular to said internal filter channel.

Although the channel may be angled provided that the upper end is above the lower end, a perpendicular channel may have advantages when used as a lubricant filling channel.

In some embodiments, said channel within said tubular mounting portion is configured to provide a channel for lubricant from an upper surface of a lubricant reservoir of said lubricant sealed pump to said lubricant reservoir when mounted in said pump.

In some embodiments, said tubular mounting assembly comprises a lubricant deflecting means extending from an inner surface of said channel above said filter inlet and configured to deflect lubricant flowing in said channel from said upper end towards said lower end away from said filter inlet

Where the channel in the tubular mounting assembly is used for lubricant filling, then inhibiting flow of the lubricant into the filter is desirable, thus some embodiments comprise a deflecting means for deflecting the flow away from the inlet.

Although the deflecting means may have a number of forms in some embodiments, said deflecting means comprises a protruding surface extending from an inner surface of said tubular mounting assembly.

In some embodiments, said means for retaining said plug is in an inner surface of said tubular mounting assembly adjacent to an opening at said upper end and said tubular mounting assembly comprising a flange extending around said upper end, said flange comprising an area for receiving a sealing means.

Where the means for retaining the plug is on the inner surface of the tubular mounting assembly then the plug may extend into the tube. In such a case the tubular mounting assembly may be configured to extend to a cover covering the lubricant reservoir of the pump and the tubular mounting means may have a flange to seal to a lower surface of the cover and the plug will seal to the upper surface of the cover.

In other embodiments, said means for retaining said plug is in an outer surface of said tubular mounting assembly and said tubular mounting assembly comprises a flange below said means for retaining said plug, said flange comprising an area for receiving a sealing means.

Where the means for retaining the plug is on the outer surface then the tubular mounting assembly may be configured to extend beyond the cover and comprise a flange below the means for retaining configured to seal to the lower surface of the cover. In this case the plug will have a flange to seal to the upper surface of the cover.

In either case as can be understood the plug is configured to be on the other side of the cover to the tubular mounting assembly and when the cover is no longer secured to the reservoir, lifting of the plug can lift the filter and cover together and this can be an effective way of removing the filter while not contacting lubricant.

In some embodiments, said tubular mounting assembly comprises filter handling protrusions extending from an outer surface of said tubular mounting assembly and located towards said upper end.

It may be advantageous for ease of handling of the filter to provide the tubular mounting assembly with protrusions near the upper end that are easily accessible when mounting or removing the filter assembly.

In some embodiments, said filter handling protrusions comprises radially outwardly extending surfaces on opposing sides of said tubular mounting assembly.

In some embodiments, said filter handling protrusion extends out from said flange.

In some embodiments, said inlet to said filter comprises an alignment portion configured to align with an inlet in said inner compartment such that said filter can be mounted only in one orientation

A further aspect provides an inner compartment for a lubricant reservoir of a lubricant sealed pump, said lubricant reservoir being configured to mount a filter assembly according to one aspect for filtering lubricant from fluid to be exhausted by said pump; said inner compartment comprising an aperture in a lower surface configured to cooperate with and receive said lower end of said tubular mounting assembly of said filter assembly.

The tubular mounting assembly is adapted to be mounted within an aperture in the base of an inner compartment of the lubricant reservoir of a lubricant sealed pump. This allows for ease of mounting by simply slotting the lower end of the tubular mounting assembly into the corresponding aperture of the lubricant reservoir, removal is also a straightforward process.

In some embodiments, said inner compartment comprises guide means in said lower surface to guide said lower end of said tubular assembly towards said aperture when mounting said filter within said inner compartment.

In some embodiments, said guide means are adjacent to said aperture in said lower surfaces.

In some embodiments, said aperture comprises cylindrical side walls configured to cooperate with walls of said lower end of said tubular mounting assembly.

In some embodiments, said inner compartment comprises said filter assembly mounted therein, and said upper side of said inner compartment comprises an opening for receiving said filter assembly, said upper end of said tubular mounting assembly extending at least as far as said opening when said tubular mounting assembly is mounted in said aperture in said base of said inner compartment.

A yet further aspect provides a lubricant sealed pump system comprising:
a lubricant sealed pump configured to pump fluid from an inlet to an exhaust; and
a lubricant reservoir for retaining lubricant and for supplying lubricant to and receiving fluid to be exhausted from said lubricant sealed pump during operation of said lubricant sealed pump; said lubricant reservoir comprising an inner compartment according to a further aspect.

In some embodiments, said inner compartment is integral with said lubricant reservoir, while in other embodiments, said inner compartment is separate to said lubricant reservoir. In some embodiments said inner compartment is made of plastic.

In some embodiments, said inner compartment comprises a filter assembly according to one aspect.

In some embodiments, said lubricant reservoir comprises a cover configured to cover said opening of said inner compartment, said cover comprising an aperture configured to align with said upper end of said tubular mounting assembly, said lubricant sealed pump system comprising a plug configured to attach to said upper end of said tubular mounting assembly.

The plug acts to seal the channel of the tubular mounting assembly or to open it when removed to allow lubricant to be added to the lubricant reservoir via the channel within the tubular mounting assembly.

In some embodiments, said plug is configured to retain said cover to said filter assembly when attached to said upper end of said tubular mounting assembly.

The plug is above the cover and thus, when in place and when the cover is no longer attached to the reservoir the plug and cover can be removed together which will pull the filter from the inner compartment allowing it to be disposed of without the need to handle the filter.

In some embodiments, said plug comprises a flange configured to mate with an upper surface of said cover, said flange comprising an area for receiving a seal.

In some embodiments the area comprises a groove.

In some embodiments, said lubricant sealed pump comprises a vacuum pump, in some embodiments a lubricant sealed rotary vane vacuum pump.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 shows a filter assembly according to an embodiment;

FIG. 2 shows a filter assembly within an inner compartment of a lubricant reservoir according to an embodiment;

FIG. 3 shows an alternative embodiment of a filter assembly within an inner compartment of a lubricant reservoir;

FIG. 4 shows the base surface of an inner compartment of the lubricant reservoir;

FIG. 5 shows a filter assembly with a deflecting means;

FIG. 6 shows a filter assembly with deflecting means mounted in an inner compartment of a lubricant reservoir and with an upper end protruding above the cover;

FIG. 7 shows a filter assembly according to an embodiment; and

FIG. 8 shows an alternative embodiment of a filter assembly within a lubricant reservoir with a deflecting means.

### DETAILED DESCRIPTION

Before discussing the embodiments in any more detail, first an overview will be provided.

Filling a lubricant sealed pump with lubricant has conventionally required a dedicated inlet with its own seal located in a dedicated area on the pump. Where the filter and the casing are compact, it may be hard to add a filling place without increasing the size of the casing. Embodiments provide an inlet that doesn't increase the casing size unduly while allowing the filling of the pump through the filtering system.

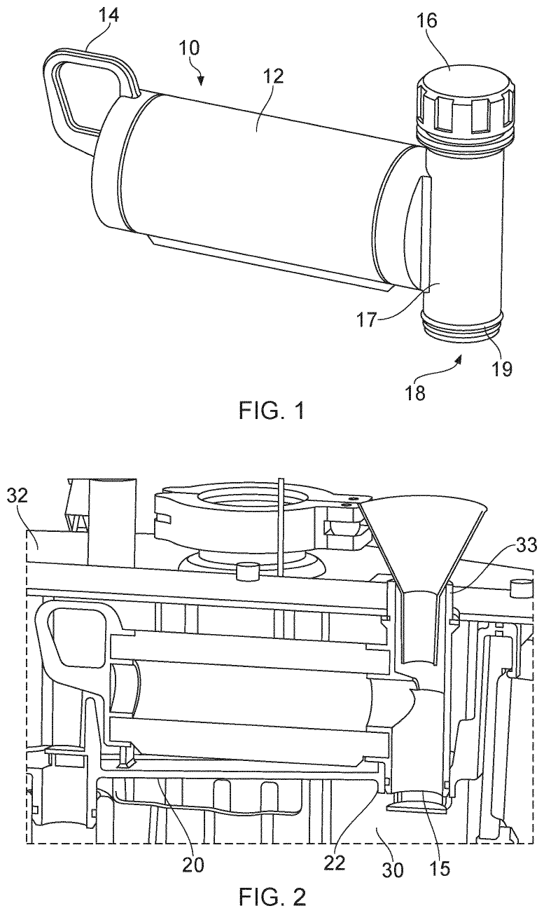

FIG. 1 shows a filter assembly 10 for a lubricant sealed pump according to an embodiment. Filter assembly 10 comprises a filter having filter material 12 surrounding an internal filter channel which in this embodiment runs substantially perpendicular to a channel in a tubular mounting portion 17. The filter assembly is configured when mounted in the pump such that exhaust fluid from the pump flows into an opening in the lower end 18 of the tubular assembly and then flows upwards and into the internal filter channel exiting via the filter material to an exhaust. The filter material filtering at least some of the lubricant from the exhaust fluid.

The filter portion comprises a handle 14 which may be used to hold the filter assembly 10 when removing it from and inserting it into an inner compartment of a lubricant reservoir. The filter assembly 10 comprises the tubular mounting portion 17 that has an upper end on which can be mounted a removable plug 16. When lubricant is to be added to the lubricant reservoir, then the plug 16 may be removed and lubricant may be poured into the upper end of the interior channel of the tubular portion so that it flows into the lubricant reservoir via the lower end 18. When the pump is operational the upper end of this channel is sealed by plug 16. The lower end 18 opens into the upper end of a lubricant reservoir and receives exhaust gas from the lubricant sealed pump during operation of the pump. There is a seal 19 that seals to an aperture in the base surface of an inner compartment in the lubricant reservoir. The aperture receives the lower end of the tubular portion when it is mounted to the inner compartment, allowing for ease of mounting and the seal 19 ensures that the filter assembly 10 is sealed within the inner compartment such that exhaust gasses that enter the filter exit via the filter material 12. Filter material 12 removes at least some of the lubricant that is within the exhaust gas prior to the exhaust gas being exhausted.

FIG. 2 shows how this filter assembly 10 of FIG. 1 is mounted within an inner compartment 20 of a lubricant reservoir 30. As can be seen it is mounted such that the filter material surrounding the internal filter channel is substantially horizontal and the tubular assembly extends substantially vertically. The lower end of the channel 15 within the tubular assembly has an opening that extends into the lubricant reservoir 30 and receives the exhaust gasses. There is an aperture 22 in the base of the inner compartment into which the lower portion of the tubular assembly is mounted and in this way the filter assembly can be “plugged into” the inner compartment when inserting it into the lubricant reservoir 30. The upper end of the tubular mounting assembly extends through the cover 32 of the lubricant reservoir and thus, on removal of the plug lubricant can be added via this tubular portion to the lubricant reservoir. In this way the tubular mounting portion provides both a mounting assembly for the filter assembly and a means for adding lubricant to the lubricant reservoir thereby obviating the requirement for an additional dedicated inlet.

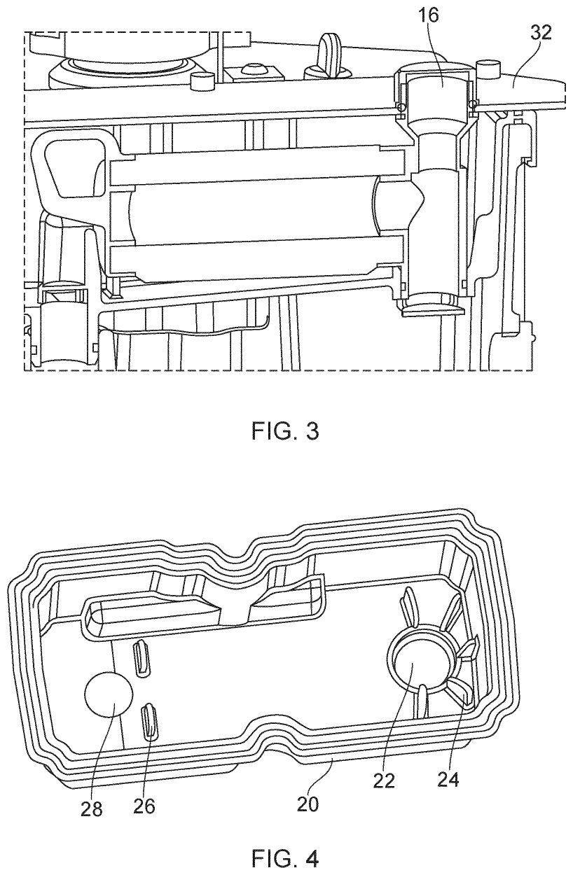

FIG. 3 shows an alternative embodiment of the filter assembly mounted in the inner compartment and in this embodiment plug 16 is shown attached to the tubular mounting assembly and sealed to cover 32. As can be understood when any retaining means for retaining the cover 32 to the lubricant reservoir are undone the cover, plug and filter assembly may be removed together. This may be a practical way of removing the filter without the need to handle the filter which will be covered in lubricant.

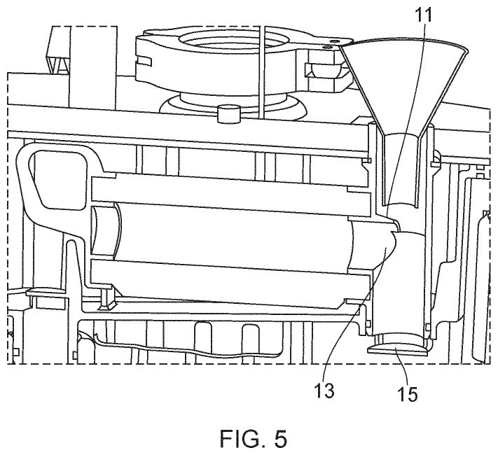

FIG. 4 shows the base of the inner compartment 20 with the aperture 22 into which the lower portion of the tubular mounted assembly is placed. There is also the exhaust outlet 28 where oil and exhaust gases that have passed through the filter material exit the inner compartment and proceed in the case of the exhaust gases to an exhaust in the pump casing and in the case of the lubricant back to the lubricant reservoir. There are guide protrusions 26 and 24 that help guide the filter into position when being mounted within the inner compartment and hold it straight. The guide protrusions 24 are around the inlet and help guide the tubular mounting assembly into this aperture 22 while the guides 26 cooperate with a guide protrusion on the bottom of the filter member and hold it straight.

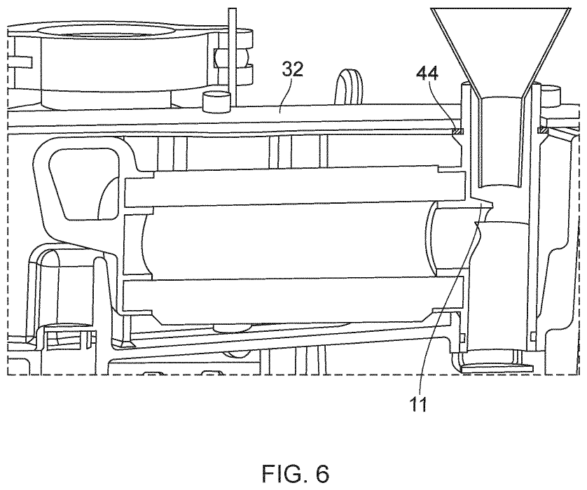

FIG. 5 shows an embodiment where the channel 15 of the tubular mounting assembly comprises a deflecting means 11 above the inlet 13 to the internal filter channel. Deflecting means 11 deflects the lubricant away from the inlet 13 to the internal filter channel and helps keep it clear of lubricant. In this embodiment the deflecting means 11 is a recess within the sidewall of the channel 15. In other embodiments, it may be a deflector extending out of the side wall of the channel or a radial position offset between the upper and the lower section of the tubular mounting

FIG. 6 shows an alternative embodiment where the mounting assembly extends above the cover 32 of the lubricant reservoir 30. The outer edge of the upper surface of the tubular assembly comprises a screw thread for receiving a plug and there is flange below this with a groove for receiving a sealing means 44 that seals to the bottom of the cover. The plug may itself have a groove on a flange with a sealing means and thus, when it is screwed onto the upper end of the tubular mounting means it will seal to the upper side of the cover 32. In this way the cover will be held between two seals.

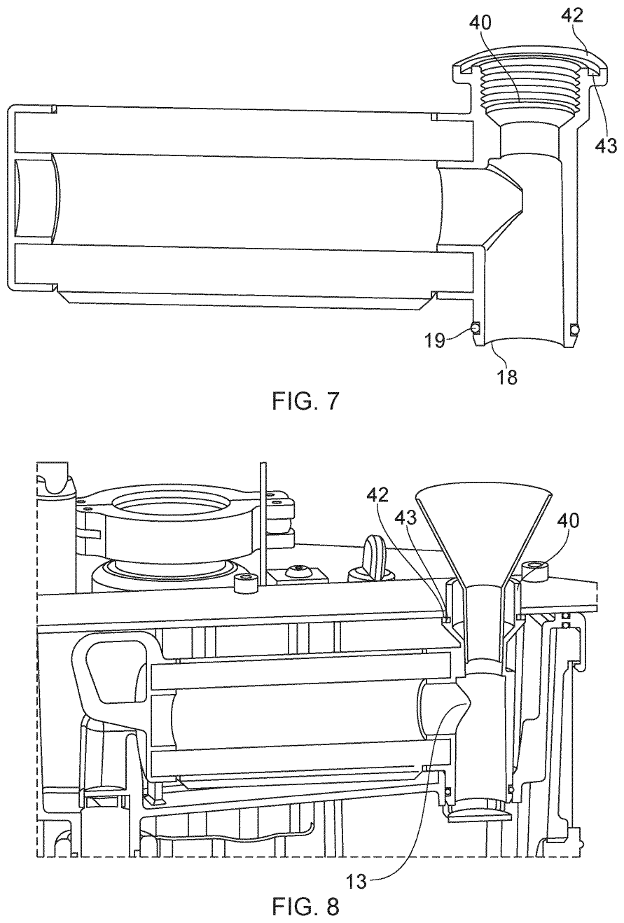

FIG. 7 shows the filter assembly of FIG. 6 in more details and shows the screw thread 40 and the flange 42 with a groove 43 for receiving a seal. There is also the seal 19 in a groove around the lower end 18 of tubular mounting assembly portion of the filter assembly.

FIG. 8 shows an alternative embodiment where the screw thread 40 is within the inner surface of the tubular mounting assembly and when a plug is inserted it extends into the tube rather than going around the edge. There is a flange 42 with a groove 43 for receiving a sealing means, which in this embodiment will seal to the lower surface of the reservoir cover. In this embodiment the tubular portion comprises a narrower portion for directing the lubricant that is added toward the centre of the channel and away from the inlet 13 to the internal filter channel, this being located below the narrower portion.

In summary a filter assembly is proposed having a filter interface, in some embodiments a tubular portion that allows the filling of the oil casing through this filter interface and removes the need for any additional hole or filling element.

Advantages of embodiments include a requirement for less material on the casing, a more compact pump, easy filling of the reservoir and easy fitting of the filter.

The filter interface may be perpendicular to the filter, or it may be at a different angle. There may be a deflector or some other separation means to inhibit oil entering the filter during filling.

The upper end of the interface may be sealed with a plug that may also seal to the lubricant reservoir cover. In addition to sealing the filter interface, the plug may also hold it in position and may be used to remove the filter and the cover together if the cover retaining means are undone.

In summary a filter with a T-Shaped inlet is provided that allows the filling of the pump. The interface/tubular portion also provides a piston fit with a filter receiving means, that may be an aperture, in the base of the inner compartment allowing a plug and play type solution. The interface portion being at end of the filter means the filter cannot be inserted the wrong way round.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A filter assembly for a lubricant sealed pump for filtering lubricant from fluid exhausted by said pump, said filter assembly comprising:
a filter comprising an inlet providing fluid communication with an internal filter channel, an outer perimeter of said internal filter channel being surrounded by filter material; and
a tubular mounting assembly;
said tubular mounting assembly defining a channel extending from an upper end of said tubular mounting assembly when said filter assembly is mounted in said lubricant sealed pump to a lower end, said filter inlet opening into said channel between said upper and said lower end.

2. The filter assembly according to claim 1, wherein said upper end of said tubular mounting assembly comprises a means for engaging with a plug.

3. The filter assembly according to claim 2, wherein said means comprises a screw thread for engaging with a corresponding screw thread on said plug.

4. A The filter assembly according to claim 1, wherein an outer perimeter of said lower end of said tubular mounting assembly comprises a receiving means for receiving a seal.

5. The filter assembly according to claim 1, wherein said channel within said tubular mounting means is substantially perpendicular to said internal filter channel.

6. The filter assembly according to claim 1, wherein said channel within said tubular mounting portion is configured to provide a channel for lubricant from an upper surface of a lubricant reservoir of said lubricant sealed pump to said lubricant reservoir.

7. The filter assembly according to claim 1, wherein said tubular mounting assembly comprises a lubricant deflecting means extending from an inner surface of said channel above said filter inlet and configured to deflect lubricant flowing in said channel from said upper end towards said lower end away from said filter inlet

8. The filter assembly according to claim 7, wherein said lubricant deflecting means comprises a protruding surface extending from an inner surface of said tubular mounting assembly.

9. The filter assembly according to claim 2, wherein said means for retaining said plug is in an inner surface of said tubular mounting assembly adjacent to an opening at said upper end and said tubular mounting assembly comprises a flange extending around said upper end, said flange comprising an area for receiving a sealing means.

10. The filter assembly according to claim 2, wherein said means for retaining said plug is in an outer surface of said tubular mounting assembly and said tubular mounting assembly comprises a flange below said means for retaining said plug, said flange comprising an area for receiving a sealing means.

11. The filter assembly according to claim 1, wherein said tubular mounting assembly comprises filter handling protrusions extending from an outer surface of said tubular mounting assembly and located towards said upper end.

12. The filter assembly according to claim 11, wherein said filter handling protrusions comprises radially outwardly extending surfaces on opposing sides of said tubular mounting assembly.

13. The filter assembly according to claim 11, wherein said upper end of said tubular mounting assembly comprises a means for engaging with a plug;
wherein said means for engaging said plug is in an inner surface of said tubular mounting assembly adjacent to an opening at said upper end and said tubular mounting assembly comprises a flange extending around said upper end, said flange comprising an area for receiving a sealing means; and
wherein said filter handling protrusions extend out from said flange.

14. An inner compartment for a lubricant reservoir of a lubricant sealed pump, said lubricant reservoir being configured to mount a filter assembly according to claim 1 for filtering lubricant from fluid to be exhausted by said pump; said inner compartment comprising an aperture in a lower surface configured to cooperate with and receive said lower end of said tubular mounting assembly of said filter assembly.

15. The inner compartment according to claim 14, said inner compartment comprising guide means in said lower surface to guide said lower end of said tubular assembly towards said aperture when mounting said filter within said inner compartment.

16. The inner compartment according to claim 14, wherein said aperture comprises cylindrical side walls configured to cooperate with walls of said lower end of said tubular mounting assembly.

17. The inner compartment according to claim 14, wherein an upper side of said inner compartment comprises an opening for receiving said filter assembly, said upper end of said tubular mounting assembly extending at least as far as said opening when said tubular mounting assembly is mounted in said inner compartment.

18. A lubricant sealed pump system comprising:
a lubricant sealed pump configured to pump fluid from an inlet to an exhaust; and
a lubricant reservoir for retaining lubricant and for supplying lubricant to and receiving fluid to be exhausted from said lubricant sealed pump during operation of said lubricant sealed pump;
said lubricant reservoir comprising an inner compartment according to claim 14.

19. The lubricant sealed pump system according to claim 18 wherein an upper side of said inner compartment comprises an opening for receiving said filter assembly. said upper end of said tubular mounting assembly extending at least as far as said opening when said tubular mounting assembly is mounted in said inner compartment and said lubricant reservoir comprises a cover configured to cover said opening of said inner compartment, said cover comprising an aperture configured to align with said upper end of said tubular mounting assembly, said lubricant sealed pump system comprising a plug configured to attach to said upper end of said tubular mounting assembly.

20. The lubricant sealed pump according to claim 19, wherein said plug is configured to retain said cover to said filter assembly when attached to said upper end of said tubular mounting assembly.

21. The lubricant sealed pump according to claim 19, wherein said plug comprises a flange configured to mate with an upper surface of said cover, said flange comprising an area for receiving a seal.
